(19) United States
(12) Patent Application Publication
(10) Pub. No.: US 2022/0416715 A1
(43) Pub. Date: Dec. 29, 2022

(54) SYSTEM FOR MOUNTING TILES OVER A SURFACE

(71) Applicant: Arka Energy Inc., Union City, CA (US)

(72) Inventors: Marath PRAKASH, Bangalore (IN); Mahadeva PRASAD H S, Chamarajanagar (D) (IN)

(21) Appl. No.: 17/846,425

(22) Filed: Jun. 22, 2022

(30) Foreign Application Priority Data
Jun. 29, 2021 (IN) 202111029220

(51) Int. Cl. H02S 20/25; E04D 1/30

(52) U.S. Cl. CPC H02S 20/25; E04D 1/30; E04D 2001/308

(57) ABSTRACT

The present disclosure relates to a system for mounting solar panel tiles (or other tiles/panels) over a roof (surface). The system includes mounting frames provided with holes at the bottom for fixing them parallelly over the roof. Bolting members and overhang members are attached to two opposite sides of the tiles to form a tile assembly. The bolting members and overhang members of the tile assembly are provided with a set of holes to allow coupling of the tile assembly between two adjacent mounting frames using bolt/screws. Further, sealing agents are provided on the edges of the tiles as well as the tile assemblies, thereby making the system aesthetically pleasing and leakproof. Another set of vents are provided on the base frames, to allow cables to pass through them, and provide proper ventilation beneath the tiles.

### TECHNICAL FIELD

The present disclosure relates to the field of solar panel mounting systems. More particularly, the present disclosure relates to a simple, efficient, and aesthetically pleasing system for mounting solar panel tiles or other tiles over a flat as well as inclined roof or other surfaces, which provides suitable ventilation beneath the solar panel tiles/tiles, has waterproofing capability, allows easier and hidden attachment of corresponding cables and power conversion devices, prevents fire, and is easy to be installed, repaired, and replaced.

### BACKGROUND

With the increase in pollution and limited non-renewable sources available, the world is switching towards renewable sources of energy. Solar power is one such renewable energy that is easily available everywhere. However, due to the amount of area required for installing solar panels and the high cost of land, people are now installing solar panels on their private building structures.

Solar panels or photovoltaic (PV) modules are generally deployed in a wide variety of ways, including deployment over the roofs, sheds, and balconies of buildings, including private homes, commercial structures, and offices. However, these panels are not readily capable of being integrated onto roof structures being constructed of standard roofing materials. This limits the usage of solar panels in a variety of locations where solar energy could otherwise be collected.

The existing system of installation of solar panels over residential rooftops involves the usage of elevated steel structures or sections for mounting the solar panels, which shows the solar panel system as a separate entity and not a part of the roof. Besides, the module size, shape, and color of the solar panels do not match with that of the roof and this leads to poor aesthetics. In addition, the existing system is not leakproof and they fail to protect the roof beneath the solar panels from wind, rain, snow, dust, and other external conditions.

In addition, since the roof remains covered by the solar panels, the temperature beneath the solar panels also rises significantly, thereby affecting the performance of solar panels and corresponding cables, and devices, and also increase the temperature inside the buildings. In severe heat conditions, the increased temperature beneath the solar panels might also completely damage the solar panel system. Also, the existing system does not have a fire-resistant capability, which makes it vulnerable to increased heat conditions or fire. In the worst case, any starting of a fire in the solar panels or the existing system may also lead to a fire breakout over the roof as well as inside the corresponding building.

Further, in the existing system, the corresponding cables and devices of the solar panels remain outside and exposed to the external environment, which may significantly damage them. Also, the existing system is difficult to be installed, repaired, and replaced due to the involvement of a large number of components, which consumes time and requires skilled personnel for installation and repairing.

Besides, another major drawback associated with existing mounting systems is their incapability to install solar panels over inclined surfaces. To install the solar panels over inclined surfaces, the existing mounting systems involve or require additional structural materials for creating the mounting platform in an upward erected manner, and also require skilled personnel to install the same. Further, such arrangement for inclined surfaces requires more area, there are chances of water entering beneath the tiles or mounting system, and the main aesthetics of the inclined surface of the structure is also lost due to the mounting structure.

Therefore, there is a need in the art to develop a simple yet efficient system or mechanism for mounting solar panel tiles or other tiles over flat as well as inclined roof or other surfaces, which has waterproofing capability, increases the performance of the solar panels by providing suitable ventilation and natural cooling, allows easier and hidden attachment of corresponding cables and power conversion devices, prevents fire, is easy to install, repair, and replace, and fulfills the aesthetics that the consumers expect.

### OBJECTS OF THE PRESENT DISCLOSURE

Some of the objects of the present disclosure, which at least one embodiment herein satisfies are as listed herein below.

It is an object of the present disclosure to provide a simple and efficient system for mounting solar panel tiles or other tiles over a roof or other surfaces. Solar panel tiles herein are also referred to as solar tiles, which are frameless solar panels.

It is an object of the present disclosure to provide a simple and efficient system for mounting solar panel tiles or other tiles over a flat as well as inclined roof or other surfaces

It is an object of the present disclosure to provide an aesthetically pleasing system for mounting solar panel tiles or other tiles over a roof or other surfaces, which shows the solar panels as a part of the roof and not as a separate addon entity, and fulfills the aesthetics that the consumers expect

It is an object of the present disclosure to provide a system for mounting solar panel tiles or other tiles over a roof or other surfaces, which is easy and affordable to be installed, repaired, and replaced, without the involvement of skilled personnel.

It is an object of the present disclosure to provide a simple, efficient, and aesthetically pleasing system for mounting solar panel tiles or other tiles over a roof or other surfaces, which provides proper ventilation beneath the assembly to facilitate convection cooling at the rear side or beneath the tiles.

It is an object of the present disclosure to provide a fireproof system for mounting solar panel tiles or other tiles over a roof or other surfaces.

It is an object of the present disclosure to provide a system for mounting solar panel tiles or other tiles over a roof or other surfaces, which is structurally stable, and less prone to structural failure due to uplift forces.

It is an object of the present disclosure to provide a system for mounting solar panel tiles or other tiles over a roof or other surfaces, which has waterproofing capability and also protects the assembly and roof from external weather conditions.

### SUMMARY

The present disclosure relates to a simple, efficient, and aesthetically pleasing system for mounting solar panel tiles or other tiles over a flat as well as inclined roof or other surfaces, which provides suitable ventilation beneath the solar panel tiles/tiles, has waterproofing capability, allows easier and hidden attachment of corresponding cables and power conversion devices, prevents fire, and is easy to be installed, repaired, and replaced.

According to an aspect of the present disclosure, the mounting system (system) may comprise mounting frames, which may be adapted to be removably configured over a surface of an area of interest (AOI) such that two adjacent mounting frames are extending parallelly and spaced apart by a predefined distance therebetween based on a dimension of tiles to be mounted thereon. The AOI may be a roof or a surface, and the tiles may be solar panel tiles, glass panels, or other aesthetic panels.

Further, bolting members and overhang members may be coupled to two opposite sides of the tile (to be mounted) to form a tile assembly. The bolting members and overhang members may be attached to the tile using adhesive or by attaching them to the laminate of the tiles. The bolting members and overhang members of the tile assembly may be adapted to be coupled to the mounting frames and facilitate mounting of the tile assembly over the surface. A row of the tile assemblies may be mounted over two adjacent mounting frames such that the bolting members of the tile assembly are coupled to one of the mounting frames, and the overhang members of the tile assembly may be coupled to the other adjacent mounting frame. This makes the assembly aesthetically pleasing, which shows the solar panels as a part of the roof and not as a separate addon entity, and fulfills the aesthetics that the consumers expect. Besides, the use of a minimal number of easily available and affordable components in the system, makes it easy and affordable to be installed, repaired, and replaced, without the involvement of skilled personnel.

In an aspect, the mounting frames may comprise a first middle section, and a first upper section, and a first lower section extending perpendicularly from two opposite ends of the first middle section in the same direction. The first lower section of the mounting frames may comprise a plurality of first holes, which may facilitate coupling of the mounting frames over the surface. Further, the first upper section of each of the mounting frames may comprise a plurality of second holes, which may facilitate coupling of the tile assemblies to the mounting frames

In an aspect, the first middle section of each mounting frame may comprise a plurality of vents that may allow air to flow therethrough. This provides proper ventilation beneath the assembly, thereby facilitating convection cooling at the rear side or beneath the tiles. Further, the vents may allow cables to pass therethrough to keep the cables hidden beneath the tiles to keep the cables hidden beneath the assembly, and making the assembly aesthetically pleasing.

In an aspect, the bolting members may comprise an edge bolting member adapted to be removably coupled at two opposite ends of one of the sides of the tiles. Further, the bolting members may comprise a center bolting members adapted to be removably coupled at a central portion of one of the sides of corresponding tiles. The bolting member may be provided with holes to facilitate the coupling of the formed tile assembly to the mounting frames.

In an aspect, the assembly may comprises one or more fixtures selected from any or a combination of bolt, screw, and clamps, to enable coupling of the mounting frames over the surface, and coupling of the bolting members, and overhang members of the formed tile assemblies on the corresponding mounting frames. This allows easier coupling as well as easier replacement of the tiles from the mounting frames as required.

In an aspect, the mounting frames, the bolting members, and the overhang members may be made of a material selected from metals, fire-retardant plastics, and fire-retardant materials. Further, a fire-resistant underlayment and a gypsum board may be configured over the surface of the AOI, and the system may be configured there over to improve the fire resistance capability of the system.

In an aspect, edges of the tiles, and edges of the corresponding tile assemblies may be provided with a sealing material selected from silicone rubber, EPDM, neoprene rubber, sealing paste, to form a leak-proof mounting system. Further, the bolting members and the overhang members may be coupled to two opposite sides of the tiles using a suitable method to form the corresponding tile assembly and provide structural support and waterproofing to the mounting system.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates an exemplary view of the proposed system for mounting a row of tiles over a surface, in accordance with an embodiment of the present disclosure.

FIG. 2 illustrates an exemplary view of the tile assembly of FIG. 1 having bolting members, and overhang members coupled to a single tile, in accordance with an embodiment of the present disclosure.

FIGS. 3A and 3B illustrate exemplary views of multiple mounting frames being parallelly attached over the surface for mounting the tiles or tile assemblies in accordance with an embodiment of the present disclosure

FIGS. 4A and 4B illustrate exemplary views of the edge bolting member, the center bolting member, respectively, of the proposed system in accordance with an embodiment of the present disclosure.

FIG. 5 illustrates exemplary views of the overhang member of the proposed assembly in accordance with an embodiment of the present disclosure.

FIG. 6 illustrates exemplary views of the mounting frame of the proposed assembly in accordance with an embodiment of the present disclosure.

FIG. 7 illustrates an exemplary view showing multiple rows of the tile assemblies being configured over the surface in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to the field of solar panel mounting systems. More particularly, the present disclosure relates to a simple, efficient, and aesthetically pleasing system for mounting solar panel tiles or other tiles over a flat as well as inclined roof or other surfaces, which provides suitable ventilation beneath the solar panel tiles/tiles, has waterproofing capability, allows easier and hidden attachment of corresponding cables and power conversion devices, prevents fire, and is easy to be installed, repaired, and replaced.

According to an aspect, the present disclosure elaborates upon a system for mounting tiles over a surface or roof The assembly can include at least two mounting frames, each adapted to be removably configured over the surface such that two adjacent mounting frames among the at least two mounting frames are extending parallelly and spaced apart by a predefined distance therebetween based on a dimension of one or more tiles to be mounted thereon. A set of bolting members, and a set of overhang members can be removably coupled to two opposite sides of the one or more tiles to form a corresponding tile assembly. Further, the set of bolting members, and the set of overhang members of the one or more tile assemblies can be adapted to be coupled to the at least two mounting frames and facilitate mounting of the corresponding tile assemblies on the at least two mounting frames. A row of the one or more tile assemblies is mounted over the two adjacent mounting frames such that the set of bolting members of the corresponding tile assembly is coupled to one of the mounting frames, and the set of overhang members of the corresponding tile assembly is coupled to the other adjacent mounting frame

In an embodiment, one or more tiles can be selected from any or a combination of solar panel tiles, glass panels, roof panels, and aesthetic panels. Further, the AOI can be selected from a roof of a building, balcony of a building, sheds, park, and land.

In an embodiment, the at least two mounting frames can include a first middle section, and a first upper section and a first lower section extending perpendicularly from two opposite ends of the first middle section in the same direction.

In an embodiment, the first lower section of each of the at least two mounting frames can include a plurality of first holes, which facilitates coupling of the at least two mounting frames over the surface. Further, the first upper section of each of the at least two mounting frames can include a plurality of second holes, which facilitates coupling of the one or more tile assemblies to the at least two mounting frames.

In an embodiment, each of the set of bolting members can include a second lower section adapted to accommodate and couple one of the sides of the one or more tiles over the corresponding bolting member to form the corresponding tile assembly, and a second upper section including one or more third holes to facilitate coupling of the corresponding tile assembly to the at least two mounting frames. Further, each of the set of overhang members can include a third lower section adapted to accommodate and couple one of the sides of the one or more tiles over the corresponding overhang member to form the corresponding tile assembly, and a third upper section including one or more fourth holes to facilitate coupling of the corresponding tile assembly to the at least two mounting frames. The third upper section, and the third lower section can extend perpendicularly from two opposite ends of a common middle section in opposite directions.

In an embodiment, edges of the one or more tiles, and edges of the corresponding tile assemblies are provided with a sealing material selected from silicone rubber, EPDM, neoprene rubber, sealing paste, to form a leak-proof mounting system.

In an embodiment, the at least two mounting frames, the set of bolting members, and the set of overhang members can be made of a material selected from metals, fire-retardant plastics, and fire-retardant materials. Further, a fire-resistant underlayment and/or a gypsum board can be configured over the surface, and the mounting system can be configured there over to improve the fire resistance capability of the mounting system.

In an embodiment, the set of bolting members, and the set of overhang members can be coupled to two opposite sides of the one or more tiles using an adhesive means or other suitable methods to form the corresponding tile assembly, and provide structural support and waterproofing to the mounting system.

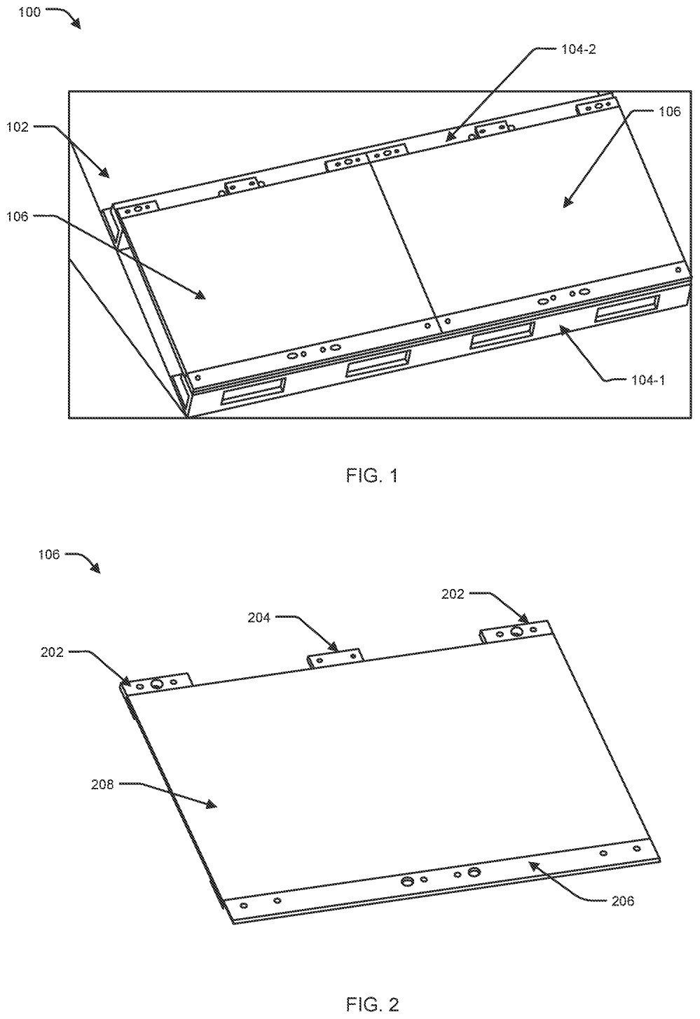

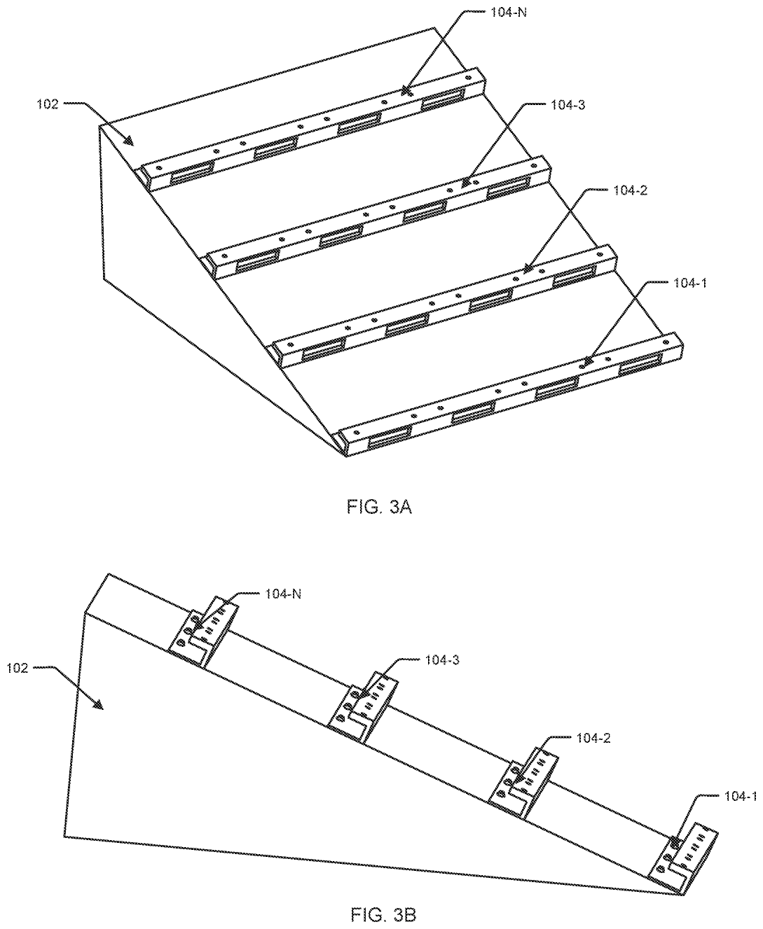

Referring to FIGS. 1 to 3B, according to an aspect, the proposed tile mounting system 100 (also referred to as system 100, herein) for mounting tiles over a surface 102 can include at least two mounting frames 104-1 to 104-N (collectively referred to as mounting frames 104 or base frames 104, herein), each adapted to be removably configured over the surface 102 of an area of interest (AOI) such that two adjacent base frames (104-1, 104-2) or (104-2, 104-3) or (104-3, 104-4) are extending parallelly and spaced apart by a predefined distance therebetween based on a dimension of one or more tiles 208 or tile assemblies 106-1 to 106-5 (collectively referred to as tile assembly 106, herein) to be mounted thereon as shown in FIGS. 1 to 3B, and 7.

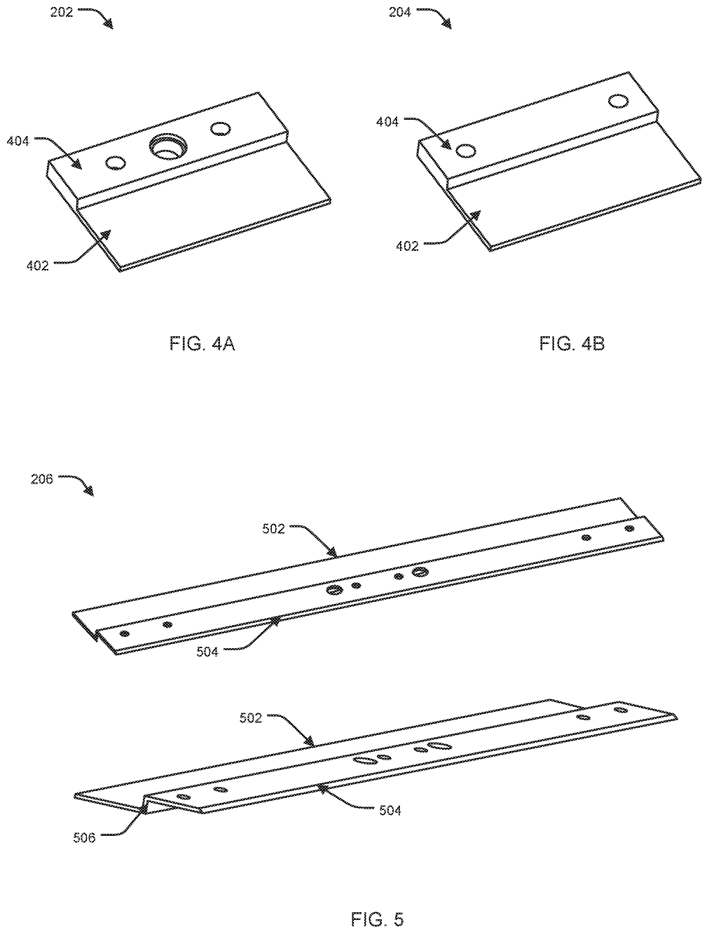

In an embodiment, as illustrated in FIGS. 2, 4A, and 4B, the system 100 can include a set of bolting members (202, 204), and a set of overhang members 206 removably coupled to two opposite sides of the tiles 208 to form a corresponding tile assembly 106 as shown in FIG. 2. The bolting members (202, 204), and the overhang members 206 of the tile assemblies 106 can be adapted to be coupled to the mounting frames 104 and facilitate mounting of the corresponding tile assemblies 106 on the mounting frames 104. A row of the tile assemblies 106 can be mounted over the two adjacent mounting frames 104-1 and 104-2 such that the bolting members (202, 204) of the corresponding tile assembly 106 is coupled to one of the mounting frames 104-2, and the overhang members 206 of the corresponding tile assembly 106 is coupled to the other adjacent mounting frame 104-1.

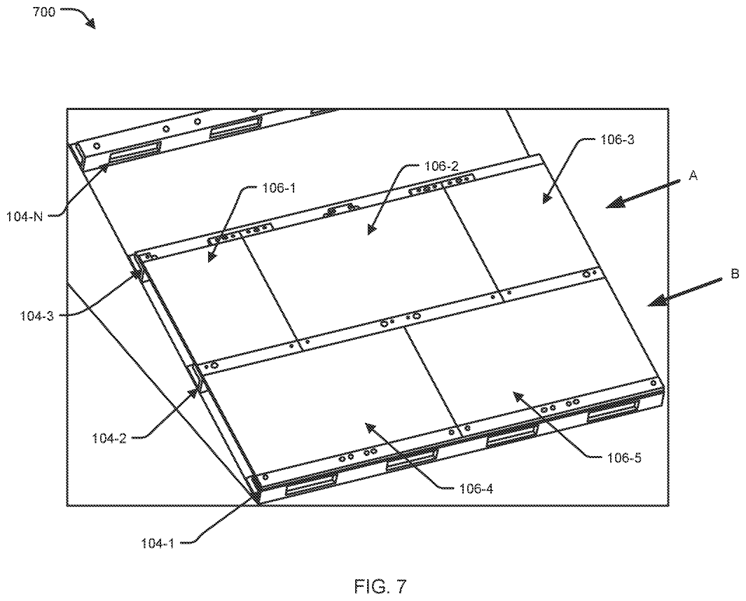

Accordingly, multiple rows (A and B) of the tile assemblies 106-1 to 106-5 can be, one by one, successfully mounted between two adjacent mounting frames (104-1 and 105-2) or (104-2 and 104-3), as shown in FIG. 7. Two adjacent rows A, B of the tile assemblies 106 can be configured in the mounting system 100 such that the overhang member 206 of the tile assemblies 106- to 106-3 associated with one of the adjacent rows (A) overlaps and couples to the bolting member (202, 204) of the tile assemblies 106-4 and 106-5 associated with another adjacent row (B) of the tile assemblies. This makes the system 100 aesthetically pleasing, which shows the solar panels or tiles 208, 106 as a part of the roof and not as a separate addon entity, fulfilling the aesthetics that the consumers expect, and further protecting the system 100 as well as the roof from external weather conditions such as rain, snow, dust, and other conditions Besides, the use of a minimal number of easily available and affordable components in the system 100, makes it easy and affordable to be installed, repaired, and replaced, without the involvement of skilled personnel.

In an embodiment, the mounting frames 104, the bolting members (202, 204), and the overhang members 206 can be made of a material selected from metals, fire-retardant plastics, and fire-retardant materials. Further, a fire-resistant underlayment and a gypsum board can be configured over the surface 102 of the AOI, and the system 100 can be configured there over to improve the fire resistance capability of the system 100.

Referring to FIG. 2, in an embodiment, tile 208 can be a solar panel tile having multiple photovoltaic modules being configured over a surface of the tile 208. Further, a plate, and/or rubber can be configured at the edges of each tile 208 using an adhesive, such that the edges of the solar panel tiles 208 can be attached to the bolting members (202, 204) and the overhang members 206 to form a leak-proof tile assembly 106.

In an embodiment, edges of the tiles 208 as well as the edges of the corresponding tile assemblies 106 can be provided with a sealing material selected from silicone rubber, EPDM, neoprene rubber, sealing paste, to form the leak-proof mounting system. Further, the bolting members (202, 204), and the overhang members 206 can be coupled to two opposite sides of the tiles 208 using a suitable method including but not limited to an adhesive tape or adhesive paste, to form the corresponding tile assembly 106, and provide structural support and waterproofing to the mounting system 100.

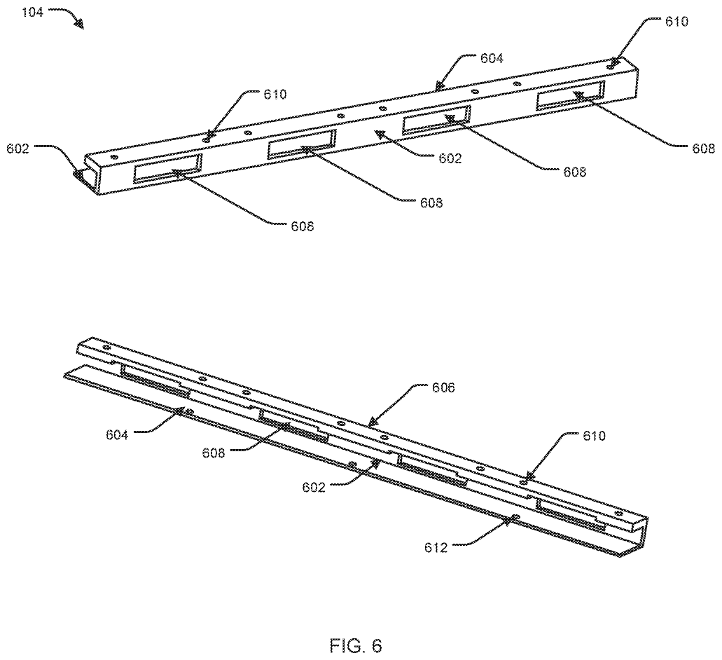

Referring to FIG. 6, in an embodiment, the mounting frames 104 can include a first middle section 602, a first upper section 604, and a first lower section 606 extending perpendicularly from two opposite ends of the first middle section 602 in the same direction. The first lower section 606 of the mounting frames can include a plurality of first holes 612, which can facilitate coupling of the mounting frames 104 over the surface 102. Further, the first upper section 604 of each of the mounting frames 104 can include a plurality of second holes 610, which can facilitate coupling of the tile assemblies 106 to the mounting frames 104.

In an embodiment, the first middle section 602 of each mounting frame 104 can include a plurality of vents 608 that can allow air to flow therethrough. This provides proper ventilation beneath the system 100, thereby facilitating convection cooling at the rear side or beneath the tiles 208 or tile assembly 106. Further, the vents 608 of the mounting frames 104 can also allow cables to pass therethrough to keep the cables hidden beneath the tiles 106 to keep the cables hidden beneath the system 100 or tile assembly 106, and making the system 100 aesthetically pleasing. The cables can be associated with the solar panel tiles 208 and the corresponding power conversion devices. The cable can then be fixed to the surface 102 using clips, and other suitable means.

Referring to FIG. 4A, in an embodiment, the set of bolting members (202, 204) can include a set of edge bolting members 202 adapted to be removably coupled at two opposite ends of one of the sides of the tiles 208. Further, referring to FIG. 4B, in an embodiment, the set of bolting members (202, 204) can include a set of center bolting members 204 adapted to be removably coupled at a central portion of one of the sides of the tiles 208. Each of the bolting members (202, 204) can include a second lower section 402 adapted to accommodate and couple one of the sides of the tiles 208 over the corresponding bolting member (202 or 204) to form the corresponding tile assembly 106, and a second upper section 404 including one or more third holes to facilitate coupling of the corresponding tile assembly 106 to the mounting frames 104.

Referring to FIG. 5, in an embodiment. the overhang members 502 can include a third lower section 602 adapted to accommodate and couple one of the sides of the tiles 208 over the corresponding overhang member 206 to form the corresponding tile assembly 106, and a third upper section 604 including one or more fourth holes to facilitate coupling of the corresponding tile assembly 106 to the mounting frames 104. The third upper section 604, and the third lower section 602 can extend perpendicularly from two opposite ends of a common middle section 606 in opposite directions.

In an embodiment, system 100 can include one or more fixtures selected from any or a combination of bolt, screw, and clamps, to enable coupling of the mounting frames 104 over the surface 102, and coupling of the bolting members (202, 204), and the overhang members 206 of the formed tile assemblies 106 on the corresponding mounting frames 104. The corresponding holes of the mounting frames 104, and the bolting members (202, 204) or the overhang members 206 can be positioned and configured such that while coupling them, the corresponding holes can be in line with one another, and the fixtures can pass through the corresponding holes.

Those skilled in the art would appreciate that embodiments of the present disclosure utilize various novel and inventive features by providing a simple yet efficient system for mounting solar panel tiles or other tiles over a falt as well as inclined roof or other surfaces, which has waterproofing capability, increases performance of the solar panels by providing suitable ventilation, allows easier and hidden attachment of corresponding cables and power conversion devices, prevents fire, is easy to install, repair, and replace, and fulfills the aesthetics that the consumers expect.

Further, it is to be appreciated by a person skilled in the art that while various embodiments and drawings of the present disclosure have been elaborated by considering four mounting frame, two bolting members, one overhang member, and up to five tiles, however, the number of the mounting frame, the bolting members, the overhang members, and rows of tiles, are not just limited to the given number but can be of any number based on the requirement of the user, and all such embodiments are well within the scope of the present disclosure.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### Advantages of the Present Disclosure

The present disclosure provides a simple and efficient system for mounting solar panel tiles or other tiles over a roof or other surfaces. Solar panel tiles herein are also referred to as solar tiles, which are frameless solar panels.

The present disclosure provides a simple and efficient system for mounting solar panel tiles or other tiles over a flat as well as inclined roof or other surfaces

The present disclosure provides an aesthetically pleasing system for mounting solar panel tiles or other tiles over a roof or other surfaces, which shows the solar panels as a part of the roof and not as a separate addon entity, and fulfills the aesthetics that the consumers expect

The present disclosure provides a system for mounting solar panel tiles or other tiles over a roof or other surfaces, which is easy and affordable to be installed, repaired, and replaced, without the involvement of skilled personnel.

The present disclosure provides a simple, efficient, and aesthetically pleasing system for mounting solar panel tiles or other tiles over a roof or other surfaces, which provides proper ventilation beneath the assembly to facilitate convection cooling at the rear side or beneath the tiles.

The present disclosure provides a fireproof system for mounting solar panel tiles or other tiles over a roof or other surfaces.

The present disclosure provides a system for mounting solar panel tiles or other tiles over a roof or other surfaces, which is structurally stable, and less prone to structural failure due to uplift forces.

The present disclosure provides a system for mounting solar panel tiles or other tiles over a roof or other surfaces, which has waterproofing capability and also protects the assembly and roof from external weather conditions.

We claim:

1. A mounting system for mounting tiles over a surface, the mounting system comprising:
at least two mounting frames, each adapted to be removably configured over the surface such that two adjacent mounting frames among the at least two mounting frames are extending parallelly and spaced apart by a predefined distance therebetween based on a dimension of one or more tiles to be mounted thereon; and
a set of bolting members, and a set of overhang members removably coupled to two opposite sides of the one or more tiles to form a corresponding tile assembly, wherein the set of bolting members, and the set of overhang members of the one or more tile assemblies are adapted to be coupled to the at least two mounting frames and facilitate mounting of the corresponding tile assemblies on the at least two mounting frames; and
wherein a row of the one or more tile assemblies is mounted over the two adjacent mounting frames such that the set of bolting members of the corresponding tile assembly is coupled to one of the mounting frames, and the set of overhang members of the corresponding tile assembly is coupled to the other adjacent mounting frame.

2. The mounting system as claimed in claim 1, wherein the at least two mounting frames comprises a first middle section, and a first upper section, and a first lower section extending perpendicularly from two opposite ends of the first middle section in same direction.

3. The mounting system as claimed in claim 2, wherein the first lower section of each of the at least two mounting frames comprise a plurality of first holes, which facilitates coupling of the at least two mounting frames over the surface, and
wherein the first upper section of each of the at least two mounting frames comprises a plurality of second holes, which facilitates coupling of the one or more tile assemblies to the at least two mounting frames.

4. The mounting system as claimed in claim 2, wherein the first middle section of each of the at least two mounting frames comprises a plurality of vents that facilitate any or a combination of:
allowing air to flow therethrough to keep the bottom of the one or more tiles cool; and
allowing one or more cables to pass therethrough to keep the one or more cables beneath the one or more tiles.

5. The mounting system as claimed in claim 1, wherein the set of bolting member comprises:
a set of edge bolting members removably coupled at two opposite ends of one of the sides of the one or more tiles; and
a set of center bolting members removably coupled at a central portion of one of the sides of corresponding tiles.

6. The mounting system as claimed in claim 1, wherein each of the set of bolting members comprises a second lower section adapted to accommodate and couple one of the sides of the one or more tiles over the corresponding bolting member to form the corresponding tile assembly, and a second upper section comprising one or more third holes to facilitate coupling of the corresponding tile assembly to the at least two mounting frames; and
wherein each of the set of overhang members comprises a third lower section adapted to accommodate and couple one of the sides of the one or more tiles over the corresponding overhang member to form the corresponding tile assembly, and a third upper section comprising one or more fourth holes to facilitate coupling of the corresponding tile assembly to the at least two mounting frames, wherein the third upper section, and the third lower section extend perpendicularly from two opposite ends of a common middle section in opposite directions.

7. The mounting system as claimed in claim 1, wherein the one or more tiles is selected from any or a combination of solar panel tile, glass panel, and roof panel, aesthetic panels, and wherein the surface is associated with an area of interest selected from a roof of a building, balcony of a building, park, and land.

8. The mounting system as claimed in claim 1, wherein edges of the one or more tiles, and edges of the corresponding tile assemblies are provided with a sealing material selected from silicone rubber, EPDM, neoprene rubber, sealing paste, to form a leak-proof mounting system.

9. The mounting system as claimed in claim 1, wherein the at least two mounting frames, the set of bolting members, and the set of overhang members are made of a material selected from metals, fire-retardant plastics, and fire-retardant materials, and wherein any or a combination of a fire-resistant underlayment and a gypsum board are configured over the surface, and the mounting system is configured thereover to improve fire resistance capability of the mounting system.

10. The mounting system as claimed in claim 1, wherein the set of bolting members, and the set of overhang members are coupled to two opposite sides of the one or more tiles using an adhesive means to form the corresponding tile assembly and provide structural support and waterproofing to the mounting system.
